(19) United States
(12) Patent Application Publication
(10) Pub. No.: US 2012/0199016 A1
(43) Pub. Date: Aug. 9, 2012

(54) Griddle Pan

(76) Inventor: Joachim Droese, Langenfeld (DE)

(21) Appl. No.: 13/369,371

(22) Filed: Feb. 9, 2012

(30) Foreign Application Priority Data
Feb. 9, 2011 (DE) 10 2011 010 812.2
Sep. 23, 2011 (EP) 11007791.4

(51) Int. Cl. A47J 37/10

(52) U.S. Cl. 99/425

(57) ABSTRACT

A griddle pan comprises a pan body having sides and an inside bottom defining a perimeter at which the sides protrude upward from the inside bottom. The inside bottom has a center and an upper face on which protrude upwardly rising ribs upon which food to be grilled is laid. The ribs have outside ends disposed at a distance from the sides. The ribs have upper surfaces all lying in a same horizontal, non-curvilinear plane and define intervening spaces therebetween. In the intervening spaces between the ribs, the inside bottom slopes from the center to the outside ends of the ribs and toward the sides.

### CROSS-REFERENCE TO RELATED APPLICATIONS

This application claims the priority, under 35 U.S.C. §§119 and 371, of German Patent Application No. 10 2011 010 812.2, filed Feb. 9, 2011, and European Patent App. No. 11007791.4 filed on Sep. 23, 2011, the prior applications are herewith incorporated by reference in their entirety.

### STATEMENT REGARDING FEDERALLY SPONSORED RESEARCH OR DEVELOPMENT

Not Applicable

### FIELD OF THE INVENTION

The present invention lies in the field of cookware. The present disclosure relates to a griddle pan or griddle plate.

### BACKGROUND OF THE INVENTION

Griddle pans or griddle plates are known which exhibit ribs formed on and rising upward from the flat inside bottom, upon which the food to be grilled and particularly a steak is laid. Fat collects between the ribs, beneath the food being grilled, and prevents the fat from easily exiting the food being grilled.

Thus, a need exists to overcome the problems with the prior art systems, designs, and processes as discussed above.

### SUMMARY OF THE INVENTION

The invention provides a griddle pan or griddle plate that overcomes the hereinaforementioned disadvantages of the heretofore-known devices and methods of this general type and that provide such features with improved grilling quality.

The invention refers to a griddle pan or griddle plate with an inside bottom and sides protruding upward at the perimeter or circumference of the inside bottom. The upper face of the inside bottom exhibits upwardly rising ribs upon which the food to be grilled is laid. The ends of the ribs are at a distance from the sides.

The intervening spaces between the ribs on the inside bottom slope from its center to the outside ends of the ribs and toward the sides and the upper surfaces of the ribs are all in the same, horizontal, non-curvilinear plane.

The fat discharged by the food being grilled is routed away from the food and toward the sides of the griddle pan or the griddle plate. In this way, the fat can more readily exit or be carried away from the food being grilled.

In an advantageous exemplary embodiment, some or all of the ribs are each formed by a row, in particular, a straight row, of rising nubs, so that the fat can flow away even better.

In particular exemplary embodiments, a height differential of the inside bottom within the intervening spaces between the center of the bottom and the outside ends of the ribs is greater than 3 millimeters. Further, the ribs have a width of between 0.3 centimeters and 5 centimeters, in particular, between 1 centimeter and 3 centimeters. Also, the intervening spaces between the ribs have a width of between 0.3 centimeters and 5 centimeters.

Advantageously, the width of the ribs is greater than the width of the intervening spaces. Alternatively, the width of the intervening spaces is greater than the width of the ribs. In a further exemplary embodiment, the ribs and intervening spaces exhibit identical widths. The ribs may also be arranged parallel to one another and in a V-shaped herringbone pattern.

With the foregoing and other objects in view, there is provided, in accordance with the invention, a griddle pan comprises a pan body having sides and an inside bottom defining a perimeter or circumference at which the sides protrude upward from the inside bottom. The inside bottom has a center and an upper face on which protrude upwardly rising ribs upon which food to be grilled is laid. The ribs have outside ends disposed at a distance from the sides and upper surfaces all lying in a same horizontal, non-curvilinear plane and define intervening spaces therebetween. In the intervening spaces between the ribs, the inside bottom slopes from the center to the outside ends of the ribs and toward the sides.

With the objects of the invention in view, there is also provided a griddle pan comprises a pan body having sides and an inside bottom defining a perimeter or circumference at which the sides protrude upward from the inside bottom. The inside bottom has a center and an upper face on which protrude upwardly rising ribs upon which food to be grilled is laid. The ribs have outside ends disposed at a distance from the sides, a width of between 0.3 centimeters and 5 centimeters, and upper surfaces all lying in a same horizontal, non-curvilinear plane and define intervening spaces therebetween having a width of between 0.3 centimeters and 5 centimeters. The inside bottom, in the intervening spaces between the ribs, slopes from the center to the outside ends of the ribs and toward the sides such that a height differential of the inside bottom within the intervening spaces defined from the center of the inside bottom to a portion of the inside bottom at the outside ends of the ribs is greater than 3 millimeters.

In accordance with another feature of the invention, at least one rib is formed by a row of rising nubs.

In accordance with a further feature of the invention, a plurality of the ribs each comprise a row of rising nubs.

In accordance with an added feature of the invention, the row of rising nubs is a straight row.

In accordance with an additional feature of the invention, a height differential of the inside bottom within the intervening spaces defined from the center of the inside bottom to a portion of the inside bottom at the outside ends of the ribs is greater than 3 millimeters.

In accordance with yet another feature of the invention, the ribs have a width of between 0.3 centimeters and 5 centimeters, in particular, between 1.0 centimeter and 3 centimeters.

In accordance with yet a further feature of the invention, the intervening spaces between the ribs have a width of between 0.3 centimeters and 5 centimeters.

In accordance with yet an added feature of the invention, a width of the ribs is greater than a width of the intervening spaces.

In accordance with yet an additional feature of the invention, a width of the intervening spaces is greater than a width of the ribs.

In accordance with again another feature of the invention, the ribs have a given width and the intervening spaces have a width equal to the given width.

In accordance with a concomitant feature of the invention, the ribs are parallel one to another in a V-shaped herringbone pattern.

Although the invention is illustrated and described herein as embodied in a griddle pan or griddle plate, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a plan view from above of an exemplary embodiment of a griddle pan or griddle plate with ribs situated parallel one to another and narrower than a width of intervening spaces and one exemplary row of nubs;

FIG. 2 is a vertical cross-sectional view of the griddle pan along section line A-A in FIG. 1;

FIG. 3 is a plan view from above of another exemplary embodiment of a griddle pan or griddle plate with ribs situated parallel one to another and wider than a width of the intervening spaces; and

FIG. 4 is a view from above showing a third embodiment with parallel ribs arranged in a herringbone pattern.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

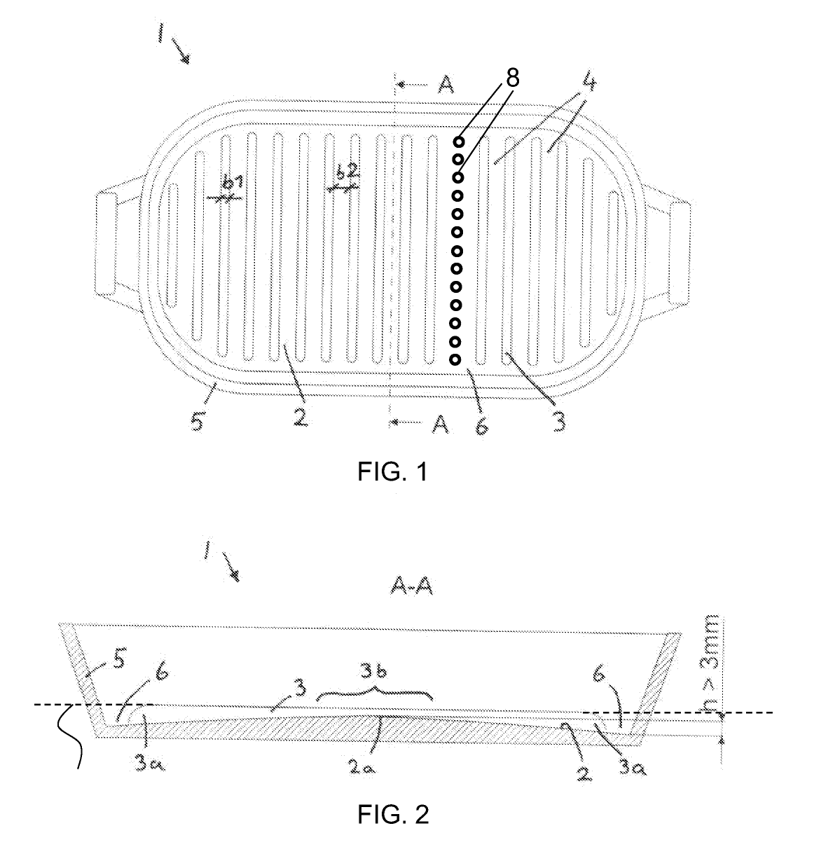

Described now are exemplary embodiments of the present invention. Referring now to the figures of the drawings in detail and first, particularly to FIG. 1, there is shown a first exemplary embodiment of a metallic griddle pan or griddle plate 1 comprising an inside bottom 2. On the upper face of inside bottom 2 are formed upwardly rising ribs 3 disposed parallel to one another and exhibiting a uniform width b1 of between 1 centimeter and 3 centimeters. Between the upwardly rising ribs 3 there are created elongated and, in particular, groove-shaped intervening spaces 4 with a uniform intervening space width b2 of between 0.3 centimeters and 5 centimeters, preferably, of between 1 centimeter and 3 centimeters.

The oblong inside bottom 2 is edged by sides 5 protruding upward at the perimeter or circumference of the inside bottom. Provided at the base of the sides 5, between the outside ends 3a of the ribs 3 and the sides 5, is a circumferential space 6 that serves as a fat collection groove 6.

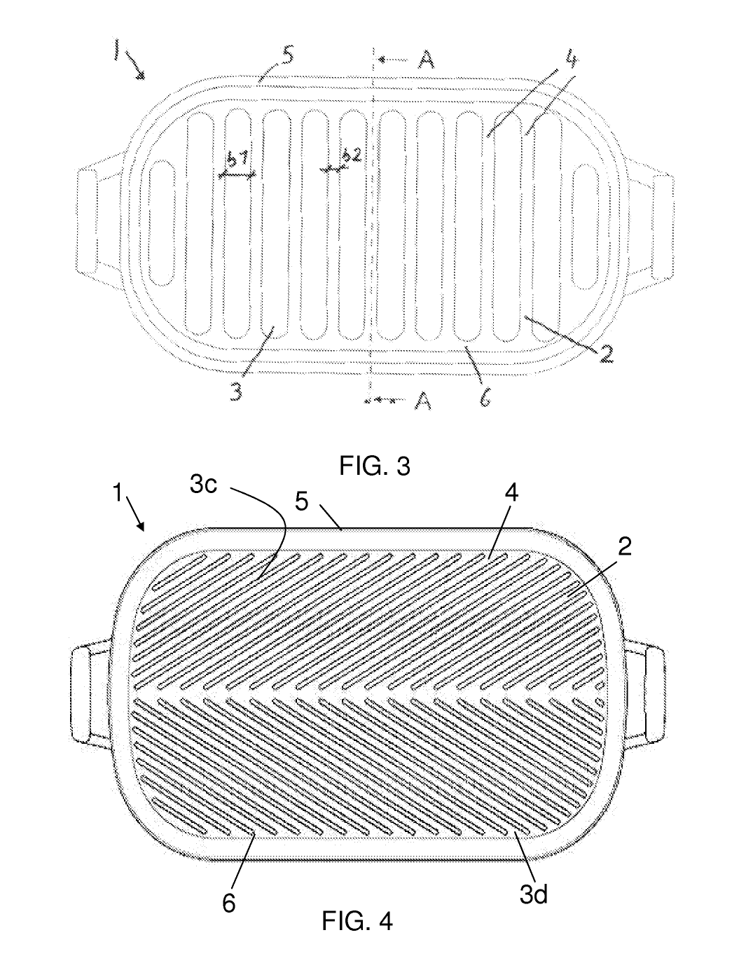

FIGS. 3 and 4 show alternatively exemplary embodiments of the griddle pan or griddle plate 1 of the invention and have similar features that are not repeated herein.

The inside bottom 2 of the griddle pan 1 is not flat or plane but, rather, is upwardly convex such that, between the ribs 3 in the area at the center of the ribs 3b, the center of the bottom 2a is higher than at the outside ends 3a of the ribs, so that the intervening spaces 4 in the area at the center of the ribs 3b are higher than at both outside ends of the intervening spaces. The result is that the fat exiting from the food being grilled flows through the intervening spaces 4 to the outside edge into the space 6 or the outside fat collection groove 6.

In contrast to the inside bottom 2, the upper surfaces of the ribs 3, upon which the food being grilled lies, are not curvilinear but, rather, lie in a horizontal, non-curvilinear plane 7 (see FIG. 2), which is higher than the bottom 2.

FIG. 3 differs from the embodiment of FIGS. 1 and 2 only in that the parallel ribs 3 are wider b1 than a width b2 of the intervening spaces 4.

FIG. 4 differs from the embodiments of FIGS. 1 to 3 only in that the parallel ribs 3 are disposed at an angle to the section line A-A and have two rib sub-sections 3c and 3d in a herringbone pattern, in particular, a V-shaped herringbone pattern. In this exemplary embodiment, a width of the ribs 3 is substantially the same as a width b2 of the intervening spaces 4.

In further exemplary embodiments, some or all of the ribs are each formed by a row, in particular a straight row, of nubs 8, so that the rib 3 is subdivided into individual nubs 8. One exemplary embodiment of a row of nubs 8 is shown in FIG. 1 for purposes of illustration only. Nubs 8 are to be understood as also including pins protruding upward and small truncated cones.

The advantages provided by the exemplary embodiments of the invention include the following:
fat discharged by the food being grilled is routed away from the food;
liquid fat discharged collects at the edge of the inside bottom; and
preparation of the food occurs with reduced fat.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A griddle pan, comprising:
a pan body having:
sides; and
an inside bottom defining a perimeter at which the sides protrude upward from the inside bottom, the inside bottom having:
a center; and
an upper face on which protrude upwardly rising ribs upon which food to be grilled is laid, the ribs:
having outside ends disposed at a distance from the sides;
having upper surfaces all lying in a same horizontal, non-curvilinear plane; and
defining intervening spaces therebetween,
in the intervening spaces between the ribs, the inside bottom sloping from the center to the outside ends of the ribs and toward the sides.

2. The griddle pan according to claim 1, wherein at least one rib is formed by a row of rising nubs.

3. The griddle pan according to claim 1, wherein a plurality of the ribs each comprise a row of rising nubs.

4. The griddle pan according to claim 2, wherein the row of rising nubs is a straight row.

5. The griddle pan according to claim 1, wherein a height differential of the inside bottom within the intervening spaces defined from the center of the inside bottom to a portion of the inside bottom at the outside ends of the ribs is greater than 3 millimeters.

6. The griddle pan according to claim 1, wherein the ribs have a width of between 0.3 centimeters and 5 centimeters.

7. The griddle pan according to claim 1, wherein the ribs have a width of between 1.0 centimeter and 3 centimeters.

8. The griddle pan according to claim 1, wherein the intervening spaces between the ribs have a width of between 0.3 centimeters and 5 centimeters.

9. The griddle pan according to claim 1, wherein a width of the ribs is greater than a width of the intervening spaces.

10. The griddle pan according to claim 1, wherein a width of the intervening spaces is greater than a width of the ribs.

11. The griddle pan according to claim 1, wherein the ribs have a given width and the intervening spaces have a width equal to the given width.

12. The griddle pan according to claim 1, wherein the ribs are parallel one to another in a V-shaped herringbone pattern.

13. A griddle pan, comprising:
a pan body having:
sides; and
an inside bottom defining a perimeter at which the sides protrude upward from the inside bottom, the inside bottom having:
a center; and
an upper face on which protrude upwardly rising ribs upon which food to be grilled is laid, the ribs:
having a width of between 0.3 centimeters and 5 centimeters;
having outside ends disposed at a distance from the sides;
having upper surfaces all lying in a same horizontal, non-curvilinear plane; and
defining intervening spaces therebetween having a width of between 0.3 centimeters and 5 centimeters,
the inside bottom, in the intervening spaces between the ribs, sloping from the center to the outside ends of the ribs and toward the sides such that a height differential of the inside bottom within the intervening spaces defined from the center of the inside bottom to a portion of the inside bottom at the outside ends of the ribs is greater than 3 millimeters.

14. The griddle pan according to claim 13, wherein at least one rib is formed by a row of rising nubs.

15. The griddle pan according to claim 13, wherein a plurality of the ribs each comprise a row of rising nubs.

16. The griddle pan according to claim 14, wherein the row of rising nubs is a straight row.

17. The griddle pan according to claim 13, wherein the ribs have a width of between 1.0 centimeter and 3 centimeters.

18. The griddle pan according to claim 13, wherein the ribs are parallel one to another in a V-shaped herringbone pattern.
